(19) United States
(12) Patent Application Publication
(10) Pub. No.: US 2004/0181603 A1
(43) Pub. Date: Sep. 16, 2004

(54) Device, method and system for enhanced routing in mobile ip networking

(76) Inventor: Jarno Rajahalme, Kirkkonummi (FI)

Correspondence Address: Robert M Bauer, Brown Raysman Millstein Felder & Steiner, 900 Third Avenue, New York, NY, 10022, US

(21) Appl. No.: 10/486,936

(22) PCT Filed: Aug. 16, 2001
(86) PCT No.: PCT/EP01/09461

(51) Int. Cl. G06F 15/16

(52) U.S. Cl. 709/230; 709/245

(57) ABSTRACT

A device and method for Mobile IP, wherein a mobility related binding cache is provided outside an individual correspondent node and managed on behalf of the correspondent node. Thus, the correspondent node may serve a mobile host without requiring additional functionality or configuration of correspondent nodes. This simplifies security policy management and allows to impart additional processing capacity for authenticating and authorizing the binding update requests to the thus proposed network entity instead of to the correspondent node separately.

### FIELD OF THE INVENTION

The present invention relates to a device, system and method for improved mobile Internet protocol support in Mobile Internet Protocol communications, and in particular concerns a device, system and method for enhanced Mobile Internet Protocol routing in communication networks.

### BACKGROUND OF THE INVENTION

With ongoing development of mobile and wireless communications systems and networks in recent years along with the availability of ever growing varieties of portable or mobile devices providing enhanced connectivity, in particular information and messaging resources and services offered by the Internet increasingly attract attention.

Although the Internet has long been stationary and become, in a sense, portable only before long, today's efforts are to a considerable extent concentrated on mobile computing and networking in which activities are not disrupted when a user changes his equipment's point of attachment to the Internet, but all required reconnection is done automatically and noninteractively.

To this effect, the Mobile Internet Protocol (Mobile IP) has been proposed as a standard protocol that builds on the Internet Protocol (IP), from version 4 (IPv4) on and further enhanced in version 6 (IPv6), in order to make mobility transparent to applications and existing higher level protocols.

Thereby, effective deployment of Mobile IP (IPv6, or IPv4 with route optimization) essentially depends on the support for Mobile IP by so called correspondent nodes, such as IP network servers like e.g. web servers, email servers, streaming media servers, instant messaging servers, telephony servers, proxy servers and the like, or IP peer terminals. Routing to correspondent nodes is done based on the destination address in the IP packets. However, direct routing from the correspondent nodes back to the mobile node depends on a binding cache being maintained by the correspondent node. Entries in the binding cache maintain a mapping between the longer term home address of the mobile node, and the shorter term care-of address of the mobile node. Without the binding cache packets to the mobile node will be routed via the home address, which may introduce significant additional routing processing and thus delay to the packet delivery. With binding cache the correspondent node will be able to route the packet directly to the mobile node's current care-of address, thus avoiding unnecessary routing processing and associated delay.

Mobility, however, gives rise to significant security problems in terms of ensuring IP packet delivery only to the intended receiver. This is extremely important, since otherwise e.g. a rogue host could claim a mobile node's IP connectivity, so that the correspondent node would not any more communicate with the real mobile node, or host, having the home address in question, but all traffic for that address would be directed to the rogue host instead.

Therefore, it is the responsibility of the correspondent node to authenticate a mobile node sending a binding update and to authorize the mobile node to be allowed to claim ownership of the claimed home address. This is carried out by a so-called binding cache management.

It is, however, undesirable to add the additional computational overhead of such binding cache management, and security functionalities, configuration and management related thereto, to the responsibility of some correspondent hosts for the following reasons.

A first reason is that in e.g. a server pool, in which individual server load typically reaches maximum values during high traffic in certain periods of day, any additional computational and/or storage load would result in the need to incorporate additional servers into the pool.

A second reason resides in the possibility that a mobile IP user terminal may be in contact with an arbitrary number of individual servers from the same pool. In this case each server would separately process the transmitted binding updates, i.e. the messages supplying a new binding to an entity that needs to know a new care-of address for a mobile node, which accordingly would add to the overall load of the server pool or farm. In addition, if a load balancing method is used in which IP packets to a single IP address are distributed to a number of separate hosts for processing, it is conceivable that only one individual server receives the binding update from the mobile host, causing the mobile node to send a virtually unlimited number of additional binding updates even if a positive binding acknowledgment was returned by an individual server host.

As a third reason, Internet service providers of the correspondent node do in general have no economical motive to add support for mobile IP into each correspondent node. If Mobile IP is not supported by correspondent nodes, all traffic for the mobile node would be sent via the mobile node's home agent and therefore add to the traffic load of both home agent and home network, because packets routed via the home agent usually take a longer route than packets routed directly from the correspondent host to the current network point of attachment of the mobile node.

Accordingly, there are two main drawbacks to mobile IP support in correspondent nodes that present significant problems for Internet service providers: the first is that mobile IP binding updates upon processing translate into IP layer binding cache entries that take both space and processing time from each correspondent node; and the second is that in order to process the binding update, each correspondent node must perform security processing, such as Internet Protocol security (IPsec) processing including key management, session key generation and the like or any other suitable security processing, resulting in significant computational overhead and additional states requiring to be maintained for each connected host beyond the lifetime of e.g. individual Transfer Control Protocol (TCP) connections.

The afore-mentioned drawbacks in particular may develop into practically unmanageable burdens in a case in which, for example, an individual server serves a large number of short service requests from a large number of individual client mobile hosts.

### SUMMARY OF THE INVENTION

In view of the above, the object of the invention thus resides in providing a device, method and system that add support for mobile IP to an existing network in such a way that correspondent hosts forming part of the existing networks need not be changed in any way, and that management of security associations and policies is simplified for the correspondent host side as a whole.

According to the invention, this object is achieved by a device as defined in claim 1, a method as-defined in claim 16, and a system as defined in claim 25, respectively.

Advantageous further developments of the invention are subject of the accompanying dependent claims.

In particular, a device for Internet protocol routing is provided, which is characterized by maintaining means arranged to maintain mobility related binding cache outside an individual correspondent node; and managing means arranged to manage said binding cache on behalf of the correspondent node.

Accordingly, the proposed network device and corresponding method provides the capability of maintaining and managing the binding cache required in mobile IP packet delivery outside an individual correspondent host and also of taking care of the associated security functions, thus offloading all mobile IP correspondent node related functionality from an individual correspondent host.

According to an advantageous further development, the device may further comprise examining means arranged to examine each packet being routed through the device for IP address binding related messages; processing means arranged to process said address binding related messages detected in a packet, including any necessary signaling for the completion of the address binding process; and binding cache entry forming means arranged to form a binding cache entry in a binding cache based on said address binding process.

Such a device preferably further comprises maintaining means arranged to take care of the associated security functions.

Preferably, modification means may be arranged to remove said IP address binding related message of the packet after the processing by said processing means.

In cases in which plural correspondent nodes are present in the routing direction, the processing means may be arranged to terminate the processing of the IP address related binding messages after the first address binding process specifying the same home address to care-of address mapping has been processed.

According to an advantageous further development, the examining means can be arranged to examine each packet being routed through the device for source address and optionally a Mobile IP home address option matching to an existing binding cache entry; replacing means may be provided to replace a care-of address in a source address field of said matching packet with a the home address as specified in said matching binding cache entry; and routing means may be provided to route the packet to a correspondent node specified by the destination address in the packet.

Furthermore, removing means may be provided to remove said Mobile IP home address option from the packet after the processing by the processing means.

According to another advantageous further development, the examining means may arranged to examine the destination address of each IP packet being routed through the device for matching with a home address in an existing binding cache entry. In this case, intercepting means may be provided to intercept said matching IP packet and to tunnel the packet to the receiver's care-of address as found from said matching binding cache entry. Furthermore, adding means may be provided to add a routing header to said matching IP packet to route the packet to the receiver's care-of address as found from the matching binding cache entry.

The routing device may be located in one or a plurality of routers through which the traffic to and from the correspondent node is routed. For an individual correspondent node, the routing device may be located in an access router serving the individual correspondent node.

As another option, the routing device may be arranged as an appliance adapted to be plugged into a network of correspondent nodes and to take care of all mobile IP correspondent node related functionalities for all correspondent hosts in said network. In particular, the routing device may be provided as an extension to security appliances and/or load balancing appliances.

For an individual correspondent node, the routing device may be located in a higher level router serving the correspondent node.

Using a device constructed as set forth above, the invention thus proposes a network entity, method and system enabling the correspondent node to serve a mobile host without requiring any additional functionality for or configuration of the correspondent node itself, and to simultaneously make use of direct routing provided by the binding update sent by a mobile node (i.e. not routing packets to the mobile node via its home agent).

Hence, according to the present invention, the management of security policies is considerably simplified in comparison to the management thereof within individual correspondent hosts, and additional processing capacity for authenticating and authorizing the binding update requests can be imparted to the proposed network entity instead of being imparted to each correspondent node separately.

### BRIEF DESCRIPTION OF THE DRAWINGS

The present invention is now further detailed with reference to a preferred embodiment as the presently considered best mode of carrying out the invention, in conjunction with the accompanying drawing, in which

FIG. 1 schematically shows a structural diagram of a network for providing mobile access including a device according to a preferred embodiment.

### DESCRIPTION OF THE PREFERRED EMBODIMENT

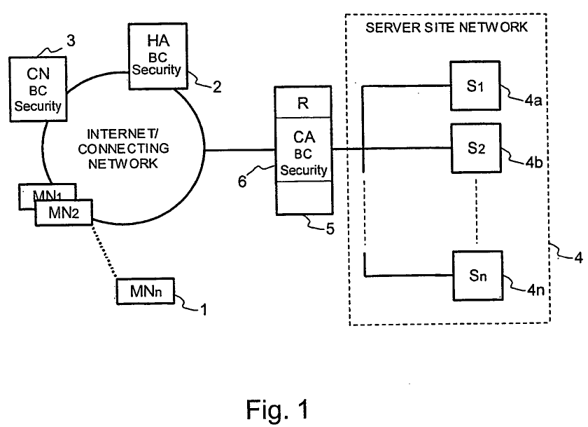

The network depicted in FIG. 1 is fundamentally based on known protocols and mechanisms developed for the Internet network layer to support mobility according to the Mobile IP specifications which add mobility support to the Internet network layer protocol IP by offering routing in a dynamic network with changes in connectivity.

To this effect, the mobile IP basically allows a mobile node (MN) 1 out of a plurality of mobile nodes MN₁ to MNₙ sending binding updates to use two IP addresses, a home address making the mobile node logically appear attached to its home network, and a so called care-of address that changes at each new point of attachment and identifies the mobile node's respective point of attachment with respect to the network topology. In the above configuration, Mobile IP requires the presence of a network node acting as a home agent (HA) 2, which tunnels packets sent to the mobile node's home address to the mobile node at its current care-of address.

In IP packet transfer, addressing is carried out using bindings containing the mobile node's home address, i.e. its address in the associated home network, the mobile node's care-of address, and a registration lifetime. Whenever a mobile node 1 moves in a foreign network, a binding update is required which is a message that supplies a new binding to a network entity that needs to know the then new care-of address for the mobile node 1.

In general, any IP node may have the property of being a mobile node or a correspondent node. Furthermore, it is noted that FIG. 1 does not show any additional routers which might be arranged for providing connections to the Internet/connecting network.

Based on the above, the present embodiment is in the following detailed by means of an example of a server farm depicted on the right hand side of FIG. 1, in which a server site network or farm 4 is linked to the Internet via an access router (R) 5 providing all Mobile IP related correspondent node, or host, processing for a number of servers (S₁, S₂, . . . Sₙ) 4a to 4n.

According to the embodiment, the servers 4a to 4n do not include any binding caches. Instead, a binding cache is maintained outside the individual correspondent nodes (e.g. S1 to Sn 4a to 4n) of the server site network 4 in a network entity or element, respectively, as proposed herein, which then provides required binding cache processing and security functions for all servers 4a to 4n in the server site network 4 and, thus, offloads all mobile IP correspondent node related functionality from the individual correspondent nodes.

The network element providing this functionality is herein called a Correspondent Agent (CA) 6 and is preferably incorporated into one or a plurality of routers, through which the traffic to and from the associated correspondent node or nodes is routed.

In general, for an individual correspondent node such as a peer mobile terminal, the Correspondent Agent 6 may be incorporated into e.g. the access router 5 or any higher level router that serves this correspondent node. As regards server site networks such as the server site network 4 shown in FIG. 1, the router(s) 5 serving the site subnet(s) is (are) in this case preferably adapted to manage the binding cache on behalf of all the servers 4a to 4n, as schematically illustrated.

More specifically, the Correspondent Agent 6 comprises fetching means that fetch IP packets coming in from the Internet/Connecting Network by detecting arriving IP packets being routed through the device, examining means that examine each arrived packet for Mobile IP binding updates contained therein, Processing means that process a binding update detected in a packet, binding cache entry forming means that form a binding cache entry in an associated binding cache outside the correspondent node based on said detected binding update, replacing means that replace the care-of address of the mobile node contained in a source address field of the binding update with a Mobile IP home address as specified in the formed binding cache entry, and routing means that route the packet then to a correspondent node.

In line with the above, a particular implementation of the Correspondent Agent 6 consists in providing a Mobile IP correspondent appliance that can be plugged into the network of the correspondent node(s) and will then take care of all mobile IP correspondent node related functionality for all the correspondent nodes in a site.

Alternatively, the Correspondent Agent 6 functionality can also be a arranged as an extension device to as such known security appliances and load balancing appliances, and in general be provided further upstream in a higher level of the access network depending on particular network dimensioning reasons.

Hereinafter, the operation of the above-mentioned correspondent agent 6 above will be schematically described.

In case of IP packets coming in from the IP network, the Correspondent Agent 6 fetches a packet by detecting and examining each incoming packet being routed through it for mobile IP binding updates and forms the binding cache entries based on the binding updates received from the mobile node 1. In other words, the binding update is addressed to the correspondent node, but processed by the Correspondent Agent 6.

In addition, the Correspondent Agent 6 may be configured to send a binding acknowledgment or any other required mobile IP signaling, as necessary.

After having processed a detected mobile IP binding update, if there are other non-mobile IP related options or payload in the packet, the packet is routed normally to the addressed correspondent node, e.g. one of the servers 4a to 4n or a “stand-alone” correspondent node 3 of the Internet/connecting network. To this effect, the contents of the incoming packet are modified in order to replace the care-of address in the source address field with the home address of the mobile node 1 as specified by either the binding cache entry or a possible mobile IP home address option.

A care-of address in the source address field of packets matching a binding cache entry can be changed to the mobile node's home address, as found from the binding cache entry. This applies to both packets containing a binding update option and all other packets.

For all incoming IP packets with a mobile IP home address, the Correspondent Agent 6 can be configured to either replace the original source address with the home address in the home address option or optionally remove the home address option from the packet, if the packet is not protected against modification. It is noted in the latter-respect that leaving the home address option in place causes no harm to the concerned correspondent node even if it processes the home address option, since both the home address option and the source address field contain the same IP address.

Additionally, if the correspondent nodes implement the home address option processing as mandated by the Mobile IP specification, there is no functional harm in leaving the home address option and the accompanying IP source address intact, since the correspondent node would use the home address in the home address option as the logical source address even if the correspondent node does not maintain a binding cache.

For IP packets sent back by the correspondent node to the mobile node 1, the Correspondent Agent 6 again intercepts the sent packets and either tunnels them to the mobile node 1, just as a home agent would do, or adds, if the packet is not protected against modification, a routing header, just as the correspondent node itself would have done if it had the binding cache located in itself (corresponding to normal Mobile IP correspondent node functionality).

In cases in which the mobile node 1 corresponds with more than one correspondent node behind the Correspondent Agent 6, the Correspondent Agent 6 may be arranged to omit or limit the processing of the binding updates after the first one received, since an active binding for the same home address to correspondent node address mapping is already present.

Moreover, the mobile node 1, recognizing that the IP packets from additional correspondent nodes will not arrive through the home agent but are directly routed, can be configured to not send any additional binding updates (even if the mobile node did not actually exchange a binding update with the individual corresponding address sending the packet).

As described above, the proposed Mobile IP Correspondent Agent 6 is a network entity maintaining a binding cache and managing Mobile IP related binding updates and security functionality on behalf of and instead of, respectively, correspondent nodes themselves. It allows e.g. existing server farms to remain untouched, while still adding support for direct routing from the correspondent nodes to the mobile IP clients. Optionally the proposed Correspondent Agent 6 allows a mobile host to manage only one binding with the entire server site, even if communicating with more than one correspondent node on the site in question. The proposed Correspondent Agent 6 further enables building Mobile IP Correspondent Agent appliance products for plug in and/or plug-and-play support of mobile clients by a server site. In addition, the Correspondent Agent functionality can also be integrated into other network elements such as access routers.

It is noted that the present invention is not restricted to any specific signaling sequence for binding cache management but can be used in connection with any possible binding cache signaling. Thus, the preferred embodiment may be modified within the scope of the attached claims.

1. A device for Internet protocol routing, characterized by
a) maintaining means arranged to maintain a mobility related binding cache outside an individual correspondent node;
b) managing means arranged to manage said binding cache on behalf of the correspondent node; and
c) replacing means arranged to replace a care-of address in the source address field of a packet sent by a mobile node with a home address as stored by said maintaining means.

2. A device according to claim 1, characterized by
examining means arranged to examine each packet, being routed through the device, for IP address binding related messages;
processing means arranged to process said IP address binding related messages detected in a packet, including any necessary signaling for the completion of the address binding process; and
binding cache entry forming means arranged to form a binding cache entry in a binding cache based on said address binding process.

3. A device according to claim 2, characterized in that
said managing means is arranged to take care of the associated security functions.

4. A device according to claim 2, characterized by
modification means arranged to remove said IP address binding related message of the packet after the processing by said processing means.

5. A device according to claim 2, characterized in that,
in cases in which plural correspondent nodes are present in the routing direction, said processing means is arranged to terminate the processing of the IP address related binding messages after the first address binding process specifying the same home address to care-of address mapping has been processed.

6. A device according to claim 1, characterized in that
examining means are provided to examine each packet being routed through said device for source address and optionally a Mobile IP home address option matching to an existing binding cache entry; and
routing means are provided to route the packet to a correspondent node specified by the destination address in the packet;
wherein said replacing means are provided to replace said care-of address in said source address field of a matching packet with a home address as specified in said matching binding cache entry

7. A device according to claim 6, characterized by
removing means arranged to remove said Mobile IP home address option from the packet

8. A device according to claim 1, characterized in that
examining means are provided to examine the destination address of each IP packet being routed through said device for matching with a home address in an existing binding cache entry.

9. A device according to claim 8, characterized by
intercepting means arranged to intercept said matching IP packet and to tunnel the packet to the receiver's care-of address as found from said matching binding cache entry.

10. A device according to claim 8, characterized by
adding means arranged to add a routing header to said matching IP packet to route the packet to the receivers care-of address as found from the matching binding cache entry.

11. A device according to any one of the preceding claims, characterized in that
said device is located in one or a plurality of routers through which the traffic to and from the correspondent node is routed.

12. A device according to claim 11, characterized in that,
for an individual correspondent node, said device is located in an access router serving the individual correspondent node.

13. A device according to any one of the preceding claims, characterized in that
said device is arranged as an appliance adapted to be plugged into a network of correspondent nodes and to take care of all mobile IP correspondent node related functionalities for all correspondent hosts in said network.

14. A device according to claim 13, characterized in that
said device is provided as an extension to security appliances and/or load balancing appliances.

15. A device according to any one of the preceding claims, characterized in that, for an individual correspondent node, said device is located in a higher level router serving the correspondent node.

16. A method for Internet Protocol routing using a Internet protocol routing device, characterized by the steps of
a) maintaining a mobility related binding cache outside an individual correspondent node;
b) managing said binding cache on behalf of the correspondent node; and
c) replacing a care-of address in the source address field of a packet sent by a mobile node with a home address as stored in said maintaining step.

17. A method according to claim 16, characterized by the steps of:
examining each packet being routed through the said routing device for IP address binding related messages;
processing the said IP address binding related messages detected in a packet, including any necessary signaling for the completion of the address binding process; and
forming a binding cache entry in a binding cache based on said address binding process.

18. A method according to claim 17, characterized in that
the address binding related contents are removed from the packet after said processing step.

19. A method according to claim 17, characterized in that
in cases in which plural correspondent nodes are present in the routing direction, the processing of address binding messages is terminated after the first address binding process specifying the same home address to care-of address mapping has been processed.

20. A method according to claim 16, characterized by the steps of
examining each packet being routed through said device for a source address and optionally a Mobile IP home address option matching to an existing binding cache entry; and
routing the packet to a correspondent node specified by the destination address in the packet;
wherein said care-of address in said source address field of a matching packet is replaced with a home address as specified in the matching binding cache entry.

21. A method according to claim 20, characterized by the step of removing said Mobile IP home address option from the packet.

22. A method according to claim 16, characterized by the step of examining each IP packet being routed through said device for a destination address matching with a home address in an existing binding cache entry, when IP packets are sent to the IP network by any corresponding node.

23. A method according to claim 22, characterized by
intercepting a matching IP packet and tunneling the packet to the receiver's care-of address as found from the matching binding cache entry.

24. A method according to claim 22, characterized by
adding a routing header to a matching IP packet to route the packet to the receiver's care-of address as found from the matching binding cache entry.

25. An Internet Protocol routing system, comprising a Mobile Internet Protocol routing device according to any one of claims 1 to 15.
